(19) United States
(12) Patent Application Publication
(10) Pub. No.: US 2025/0379350 A1
(43) Pub. Date: Dec. 11, 2025

(54) RECONFIGURABLE HYBRID COUPLER BASED ON SLOW-WAVE ARCHITECTURE

(71) Applicants: STMicroelectronics International N.V., Geneva (CH); INSTITUT POLYTECHNIQUE DE BORDEAUX, TALENCE cedex (FR); UNIVERSITE DE BORDEAUX, Bordeaux (FR); CENTRE NATIONAL DE LA RECHERCHE SCIENTIFIQUE

(72) Inventors: Andreia CATHELIN, LAVAL-en-Belledonne (FR); Eric KERHERVE, Pessac (FR); Gwennael DIVERREZ, Issou (FR)

(21) Appl. No.: 18/737,097

(22) Filed: Jun. 7, 2024

(51) Int. Cl. H01P 5/18; H01P 3/00

(52) U.S. Cl. CPC H01P 5/186; H01P 3/003

(57) ABSTRACT

An example hybrid coupler is provided. An example hybrid coupler includes two or more transmission lines, a plurality of conductive strips, and a switch. The plurality of conductive strips are positioned proximate to at least one transmission line of the hybrid coupler. The proximity of the conductive strips alters a tuning equivalent capacitance between the at least one transmission line and a reference ground plane. According to slow-wave principles, a spacing distance between the conductive strips is smaller than or similar to the dielectric gap between the transmission line and the conductive strips. The switch is electrically connected to each conductive strip of the plurality of conductive strips and the reference ground plane. The tuning equivalent capacitance between the at least one transmission line and the ground plane is adapted based on a state of the switch, changing the tuning equivalent capacitance and center frequency of the hybrid coupler.

### TECHNOLOGICAL FIELD

Embodiments of the present disclosure relate generally to hybrid couplers, and more particularly, to hybrid couplers configured for wide band operation.

### BACKGROUND

The versatility of hybrid couplers in microwave and millimeter wave architectures has made them a key component of radio frequency (RF) architectures since their introduction. The emergence of high data rate RF protocols, such as 5G, compels new constraints for RF transceivers and particularly for hybrid couplers. As a result, many power amplifiers utilize hybrid coupler-based architectures to provide power amplification with low insertion losses on RF transceivers.

Applicant has identified many technical challenges and difficulties associated with hybrid couplers. Through applied effort, ingenuity, and innovation, Applicant has solved problems related to the hybrid couplers by developing solutions embodied in the present disclosure, which are described in detail below.

### BRIEF SUMMARY

Various embodiments are directed to an example hybrid coupler, a stacked architecture hybrid coupler, and a power amplifying circuit comprising a hybrid coupler. An example hybrid coupler is provided. In some embodiments, the example hybrid coupler comprises two or more transmission lines, a plurality of conductive strips, and a switch. At least one transmission line of the two or more transmission lines is configured to transmit an electromagnetic signal from an input port to an output port, wherein a phase shift is adapted to be applied to at least a portion of the electromagnetic signal. The plurality of conductive strips are positioned proximate to the at least one transmission line, wherein each conductive strip of the plurality of conductive strips alters a tuning equivalent capacitance between the at least one transmission line and a reference ground plane. At least a spacing distance separates each conductive strip in the plurality of conductive strips. At least a dielectric gap separates each conductive strip in the plurality of conductive strips from the at least one transmission line. The spacing distance is smaller than or similar to the dielectric gap. The switch is electrically connected to each conductive strip of the plurality of conductive strips and the reference ground plane. Wherein the tuning equivalent capacitance between the at least one transmission line and the ground plane is adapted based on a state of the switch. Wherein a change in the tuning equivalent capacitance is adapted to change a center frequency of the hybrid coupler.

In some embodiments, the switch is electrically connected to a plurality of conductive strips, and the tuning equivalent capacitance is correlated with a number of conductive strips in the plurality of conductive strips.

In some embodiments, the hybrid coupler comprises a plurality of switches, wherein each switch of the plurality of switches is electrically connected to a subset of the plurality of conductive strips.

In some embodiments, the tuning equivalent capacitance is adapted based on the state of each switch in the plurality of switches.

In some embodiments, the hybrid coupler further comprises a second input port and a second output port. The output port is electrically connected to the input port by a first transmission line, and the second output port is electrically connected to the second input port by a second transmission line.

In some embodiments, the hybrid coupler comprises at least one crossing region in which the first transmission line and the second transmission line are overlaid.

In some embodiments, the hybrid coupler comprises a power combiner mode in which a first electromagnetic signal is received at the input port and a second electromagnetic signal is received at the second input port, and wherein the first electromagnetic signal and the second electromagnetic signal are combined at the output port.

In some embodiments, the hybrid coupler comprises a power divider mode in which a first electromagnetic signal is received at the input port, and wherein the first electromagnetic signal is divided into a first output signal at the output port and a second output signal at the second output port.

In some embodiments, an amplitude imbalance between the first output signal and the second output signal is at a minimum amplitude imbalance at the center frequency.

In some embodiments, the hybrid coupler further comprises a coplanar waveguide. The coplanar waveguide comprising the at least one transmission line, and one or more coplanar return conductors parallel to the at least one transmission line, wherein the one or more coplanar return conductors are separated from the at least one transmission line by a separation gap.

In some embodiments, a one decibel relative bandwidth is greater than 40%.

In some embodiments, an insertion loss is less than 2.5 decibels.

In some embodiments, the plurality of conductive strips are positioned orthogonal to the at least one transmission line.

A stacked architecture hybrid coupler is further provided. In some embodiments, the stacked architecture hybrid coupler comprises a substrate layer, a transmission layer, and a metallic layer. The transmission layer comprises two or more transmission lines, wherein at least one transmission line of the two or more transmission lines is configured to transmit an electromagnetic signal from an input port to an output port. In some embodiments, a phase shift is adapted to be applied to at least a portion of the electromagnetic signal. The metallic layer is electrically insulated from the at least one transmission line and comprises a plurality of conductive strips, at least one conductive strip positioned proximate to the at least one transmission line. Each conductive strip of the plurality of conductive strips alters a tuning equivalent capacitance between the at least one transmission line and a reference ground plane. At least a spacing distance separates each conductive strip in the plurality of conductive strips, at least a dielectric gap separates each conductive strip in the plurality of conductive strips from the at least one transmission line, and the spacing distance is smaller than the dielectric gap or similar. A switch is electrically connected to each conductive strip of the plurality of conductive strips and the reference ground plane. The tuning equivalent capacitance between the at least one transmission line and the ground plane is adapted based on a state of the switch. A change in the tuning equivalent capacitance is adapted to change a center frequency of the hybrid coupler.

In some embodiments, the metallic layer is positioned between the transmission layer and the substrate layer.

In some embodiments, the stacked architecture hybrid coupler comprises a monolithic integrated circuit.

In some embodiments, the substrate layer is part of a printed circuit board.

In some embodiments, the stacked architecture hybrid coupler comprises a second input port and a second output port. The output port is electrically connected to the input port by a first transmission line, and the second output port is electrically connected to the second input port by a second transmission line.

In some embodiments, the stacked architecture comprises at least one crossing region in which the first transmission line and the second transmission line are overlaid.

A power amplifying circuit is further provided. In some embodiments, the power amplifying circuit comprises a first hybrid coupler, a first amplifier, a second amplifier, and a second hybrid coupler. The first hybrid coupler configured in a power divider mode, comprising an input port configured to receive a first electromagnetic signal and divide the first electromagnetic signal into a first output signal on a first transmission line electrically connected to a first output port and a second output signal on a second transmission line electrically connected at a second output port. A phase shift is adapted to be applied between the first output signal and the second output signal. A first conductive strip positioned proximate the first transmission line and the second transmission line, defining a first dielectric gap between each of the first transmission line and the second transmission line and the first conductive strip. A first switch electrically connected to the first conductive strip and a first electrical ground, wherein a first tuning equivalent capacitance is adapted to be selectively generated between the first transmission line and the second transmission line and the first conductive strip based on a first switch state of the first switch. The first amplifier configured to receive the first output signal and generate an amplified first signal. The second amplifier configured to receive the second output signal and generate an amplified second signal. The second hybrid coupler configured in a power combiner mode, the second hybrid coupler comprising a first input port, a second input port, a second conductive strip, and a second switch. The first input port configured to receive the amplified first signal. The second input port configured to receive the amplified second signal. The amplified first signal and the amplified second signal are combined in a combined transmission line at an output port, and the phase shift is applied between the amplified first signal and the amplified second signal. The second conductive strip positioned proximate to the combined transmission line, defining a second dielectric gap between the combined transmission line and the second conductive strip. The second switch electrically connected to the second conductive strip and a second electrical ground, wherein a second tuning equivalent capacitance is adapted to be selectively generated between the combined transmission line and the second conductive strip based on a second switch state of the second switch.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example hybrid coupler in accordance with an example embodiment of the present disclosure.

FIG. 2A-FIG. 2B illustrate a diagram of an example hybrid coupler configured in a power divider mode and a power combiner mode, respectively, in accordance with an example embodiment of the present disclosure.

FIG. 3 depicts an example graph illustrating amplitude imbalance and insertion loss of a typical hybrid coupler.

FIG. 4 illustrates an example hybrid coupler comprising a conductive strip in accordance with an example embodiment of the present disclosure.

FIG. 5 illustrates an example hybrid coupler comprising a plurality of conductive strips in subsets in accordance with an example embodiment of the present disclosure.

FIG. 6 illustrates a front and behind view of a twisted hybrid coupler in accordance with an example embodiment of the present disclosure.

FIG. 7 illustrates an example twisted hybrid coupler comprising switch-controlled conductive strips in accordance with an example embodiment of the present disclosure.

FIG. 8A-FIG. 8B illustrates an example coplanar waveguide of a hybrid coupler and changes to the electric and magnetic field according to slow wave principles and in accordance with an example embodiment of the present disclosure.

FIG. 9 depicts a graph illustrating example amplitude imbalances at various tuning equivalent capacitances in accordance with an example embodiment of the present disclosure.

FIG. 10A-FIG. 10B depict graphs illustrating example insertion losses and phase differences with respect to a certain frequency range variation at various tuning equivalent capacitances in accordance with an example embodiment of the present disclosure.

FIG. 10C depicts transmission losses with respect to a certain range of input power, for a frequency included in the operating frequency range in accordance with an example embodiment of the present disclosure.

FIG. 11 illustrates an example power amplifier comprising a plurality of hybrid couplers in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with utilizing a hybrid coupler to perform signal operations on an RF signal with low insertion losses and up to a wide frequency bandwidth. As understood by those of skill in the field to which the present disclosure pertains, there are numerous example scenarios in which a hybrid coupler may be utilized to perform RF signal operations requiring low insertion losses and providing support for a wide frequency bandwidth.

For example, the constant demand to support multi-gigabit data rates has led to the continued development and increasing utilization of high data rate RF protocols, such as 5G, 6G, and so on. Some of these RF protocols rely on beamforming antenna arrays to transmit RF output signals. Beamforming antenna arrays induce impedance variations at the output of the power amplifying circuitry that may strongly degrade the performance of the power amplifying circuitry. Among the different techniques designed for resilience against variations in output impedance, the balanced architecture power amplifier leveraging hybrid couplers is the most commonly used due to the inherent protection the hybrid couplers provide to the internal amplifiers of the power amplifier. Such hybrid coupler-based power amplifiers further enable power output linearity, and efficiency up to a deep power back-off (PBO) power level.

In order to be utilized in such a context, the hybrid couplers included in the power amplifier preferably exhibit low insertion losses to prevent degradation of the power amplifier efficiency. In addition, the hybrid couplers included in the power amplifier preferably operate over a wide frequency bandwidth without affecting the amplifier linearity.

In some previous examples, hybrid couplers have implemented configurable variable capacitances utilizing capacitor banks. In such an example, one or more capacitors in a group of parallel capacitors may be enabled during operation of the hybrid coupler. Enabling one or more capacitors within the capacitor bank alters the capacitance on the RF signal path, effectively changing the center frequency of the hybrid coupler. Unfortunately, hybrid couplers utilizing capacitor banks introduce significant insertion losses. For example, insertion losses above 3 decibels (dB). Further, the implementation of configurable capacitor banks may occupy significant space in a circuit design.

The various example embodiments described herein utilize various techniques to support electromagnetic signal operations utilizing hybrid couplers which are configured to support a large frequency bandwidth with low insertion losses and compact area. For example, in some embodiments, the hybrid coupler described herein utilizes slow-wave line principles to expand the bandwidth of the hybrid coupler while limiting insertion losses and area consumption. The slow-wave line principle is generally used to improve the performance of passive circuits in terms of quality factor. The general objective of the slow-wave line operation is to decrease the phase velocity of the electromagnetic signal in order to reduce the guided wavelength of the electromagnetic signal. The slow-wave line principle may be applied to a transmission line to introduce a linear tuning equivalent capacitance distributed along the transmission line. The distributed tuning equivalent capacitance may be utilized to alter the center frequency of the hybrid coupler. Thus, the tuning equivalent capacitance along the transmission line of a hybrid coupler may be updated based on the frequency of the electromagnetic signal transmitted through the hybrid coupler. Adjusting the center frequency enables transmission of electromagnetic signals across a wide frequency bandwidth with minimal insertion losses.

As described herein, in some embodiments, a plurality of conductive strips may be positioned proximate to one or more transmission lines in a hybrid coupler, wherein a dielectric gap exists between the one or more transmission lines and the plurality of conductive strips. Each conductive strip of the plurality of conductive strips induces a first capacitance between the one or more transmission lines and a ground plane in an instance in which the conductive strip is grounded to the ground plane, and a second capacitance between the transmission line and the ground plane comprising two capacitances in series (e.g., a capacitance between the transmission line and the conductive strip and a capacitance between the conductive strip and the ground plane) in an instance in which the conductive strip is not grounded to the ground plane. Utilizing slow-wave principles, the conductive strips are spaced according to a spacing distance less than or equal to the dielectric gap such that the electric field of the at least one transmission line is altered but the magnetic field of the transmission line experiences little or no change.

As further described herein, the hybrid coupler may include a switch between one or more conductive strips and the ground plane. In an instance in which the switch is closed, the one or more conductive strips are grounded, inducing a change in the total equivalent capacitance between the transmission line and the ground plane. By selectively enabling the conductive strips proximate the transmission line, the tuning equivalent capacitance along the transmission line may be altered. Altering the tuning equivalent capacitance dynamically changes the center frequency of the hybrid coupler. Dynamically changing the center frequency of the hybrid coupler based on the frequency of the electromagnetic signal passing through the hybrid coupler enables operation at an increased bandwidth while limiting insertion losses.

As a result of the herein described example embodiments and in some examples, the effectiveness of a hybrid coupler may be greatly improved. For example, insertion losses may be minimized over an increased frequency bandwidth by updating the center frequency of the hybrid coupler based on the input frequency of the input signal. In addition, the amplitude imbalance of a hybrid coupler may be continuously limited over a wide bandwidth due to the dynamically updated tuning equivalent capacitance between the transmission line and the ground plane. Further, various stacked hybrid coupler architectures, such as a twisted hybrid coupler, may be utilized to reduce the overall size of the hybrid coupler while still enabling continuous update of the tuning equivalent capacitance.

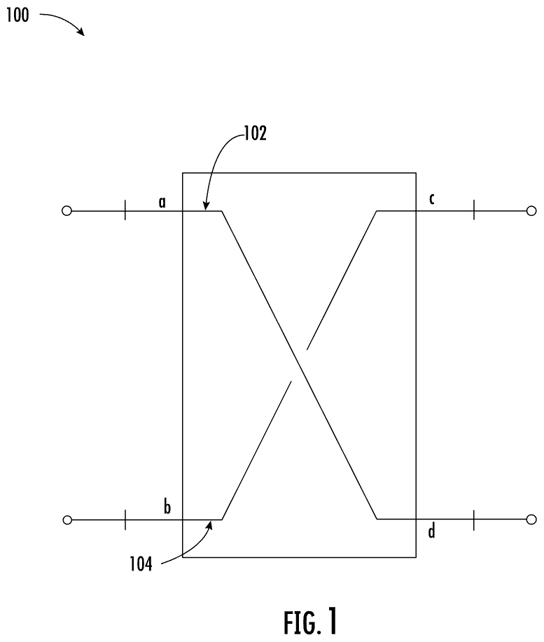

Referring now to FIG. 1, an example hybrid coupler 100 is provided. As depicted in FIG. 1, the example hybrid coupler 100 includes two input ports (100a, 100b) and two output ports (100c, 100d). The hybrid coupler 100 further includes two transmission lines (102, 104) electrically coupling the input ports (100a, 100b) to the output ports (100c, 100d). For example, as depicted in FIG. 1, the first transmission line 102 electrically couples the input port 100a to the output port 100d. Similarly, the second transmission line 104 electrically couples the input port 100b to the output port 100c.

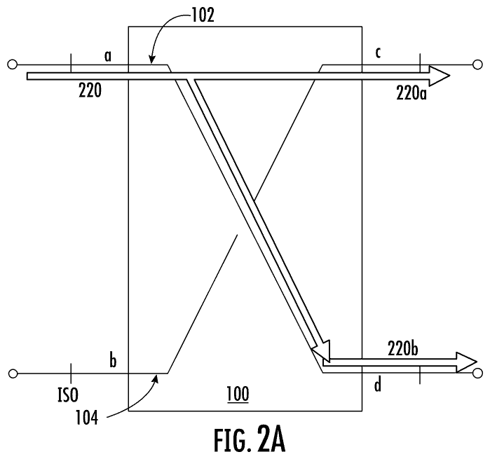

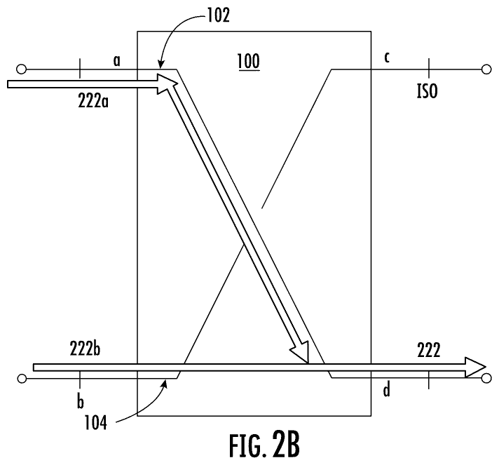

The hybrid coupler 100 may be configured to perform various electromagnetic signal operations. For example, the hybrid coupler 100 may be used to split a signal into two parts (e.g., power divider mode as further depicted in FIG. 2A) or to combine two signals (e.g., power combiner mode as further depicted in FIG. 2B). The transmission lines 102, 104 of the hybrid coupler 100 are brought into close proximity such that the transmission lines are electromagnetically coupled. As such, an electromagnetic signal on one transmission line 102, respectively 104 may be induced on the correlated transmission line 104, respectively 102.

Hybrid couplers 100 may further introduce a phase offset between the electromagnetic signals on the transmission lines 102, 104. For example, in a power divider mode, an electromagnetic signal on the first output port 100c may have a phase offset with reference to the electromagnetic signal on the second output port 100d. In some embodiments, the hybrid coupler 100 may comprise a quadrature hybrid coupler 100 which induces a phase offset of 90 degrees.

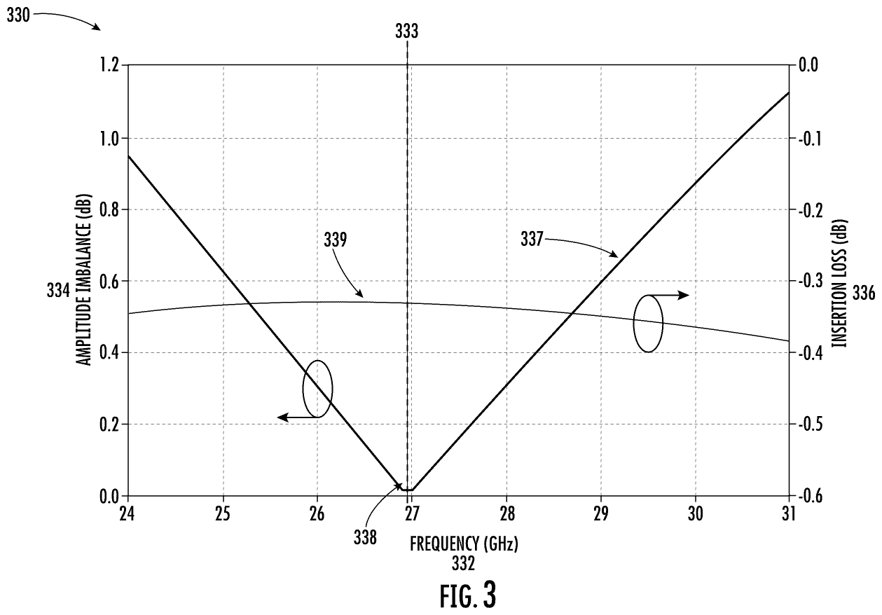

A hybrid coupler 100 may further be configured to operate at a center frequency. The center frequency of the hybrid coupler 100 may be determined based on the linear capacitance (e.g., tuning equivalent capacitance) and the linear inductance respective contributions in the transmission lines 102, 104 of the hybrid coupler 100. As further depicted in FIG. 3, the amplitude imbalance of the hybrid coupler 100 may be at a minimum at the center frequency, where the insertion losses on the two transmission lines considered independently are equal. As the frequency of the electromagnetic signal moving through the hybrid coupler moves away from the center frequency, the amplitude imbalance increases.

Utilization of hybrid couplers 100 to perform signal operations enable circuitry such as power amplifiers to be resilient to changes in voltage standing wave ratio (VSWR) of the antenna connected at its output. The VSWR may change based mostly on impedance variations on the load at the antenna and in a smaller way from components of the circuitry. The consequence of antenna VSWR can be measured by how efficiently RF power is transmitted from an electrical component to an output antenna. Antennas utilized to perform beamforming operations may experience changes in load impedance and thus variation in VSWR.

Referring now to FIG. 2A, a hybrid coupler 100 configured in a power divider mode is depicted. As depicted in FIG. 2A, the second input port 100b of the hybrid coupler 100 is configured as the isolation port. Although not pictured, the isolation port may be terminated in a load, such as a ballast resistor.

As depicted in FIG. 2A, the hybrid coupler 100 is configured to receive an input RF signal 220. An input RF signal 220 is any electromagnetic wave oscillating at a frequency within the RF spectrum. An input RF signal 220 may further be modulated to encode data. Modulation encoding techniques may include amplitude modulation (AM), frequency modulation (FM), phase shift keying (PSK), quadrature phase shift keying (QPSK), quadrature amplitude modulation (QAM), and so on. A transmitting device (not pictured) may be configured to generate the input RF signal 220 with encoded data and transmit the input RF signal 220 to the hybrid coupler 100.

The input RF signal 220 is initially transmitted through the transmission line 102. Due to the coupling of the transmission lines 102, 104, the input RF signal 220 is split into two portions (e.g., portion 220a, portion 220b). The portion 220a is transmitted across the second transmission line 104 to the first output port 100c. The portion 220b is transmitted across the first transmission line 102 to the second output port 100d. In some embodiments, the hybrid coupler 100 may exhibit 3 dB insertion losses on each of the output ports 100c and 100d due to the power split into 2 equal parts. In theory (e.g., without ohmic losses), at the center frequency, the hybrid coupler is configured to equally split the input RF signal 220 between the portion 220a on the output port 100c and the portion 220b on the output port 100d, each output receiving the input RF signal 220 with insertion losses of 3 dB. An equally split input RF signal 220 has an amplitude imbalance of 0 at the center frequency. In some embodiments, the length of the transmission lines 102, 104 may be configured to determine the center frequency. As the frequency of the input RF signal moves away from the center frequency, the amplitude imbalance of the portion 220a and the portion 220b of the input RF signal 220 increases. The amplitude imbalance of an example hybrid coupler 100 with respect to the frequency of an input RF signal 220 is further depicted in FIG. 3.

In some embodiments, the hybrid coupler 100 may induce a phase shift between the portion 220a and the portion 220b of the input RF signal 220. For example, a quadrature hybrid coupler 100 may output the first portion 220a with a 90-degree offset from the second portion 220b.

Referring now to FIG. 2B, a hybrid coupler 100 configured in a power combiner mode is depicted. As depicted in FIG. 2B, the first output port 100c of the hybrid coupler 100 is configured as an isolation port. Although not pictured in FIG. 2B, the isolation port may be terminated in a load, such as a ballast resistor, an inductor or a capacitor.

As depicted in FIG. 2B, the hybrid coupler 100 is configured to receive a first input RF signal 222a on the input port 100a and a second input RF signal 222b on the input port 100b. The input RF signal 222a is initially transmitted on transmission line 102 while the input RF signal 222b is initially transmitted on transmission line 104. Due to the coupling of the first transmission line 102 and the transmission line 104, the hybrid coupler 100 configured for operation in a power combiner mode combines the input RF signal 222a and the input RF signal 222b into a combined RF signal 222 (e.g., combined transmission line) at the output port 102d.

In some embodiments, the hybrid coupler 100 may induce a phase shift between the input RF signal 222a and the input RF signal 222b in generation of the combined RF signal 222. For example, a quadrature hybrid coupler 100 may shift the first input RF signal 222a by 90 degrees in relation to the second input RF signal 222b. In some embodiments, the phase shift induced by the hybrid coupler in power combiner mode may act to synchronize the first input RF signal 222a and the second input RF signal 222b.

A hybrid coupler is configured to combine the first input RF signal 222a and the second input RF signal 222b. The hybrid coupler in a power combiner mode combines the power of the first input RF signal 222a and the second input RF signal 222b. In an instance in which the two signals are equal in power, the resulting theoretical output power is equal to the input RF power (of one of the two input paths) plus 3 dB, assuming no ohmic losses. In some embodiments, the length of the transmission lines 102, 104 may be configured to determine the center frequency. The amplitude imbalance of an example hybrid coupler 100 with respect to the frequency of an input RF signal 222a, 222b is further depicted in FIG. 3.

Referring now to FIG. 3, an example graph 330 depicting an amplitude imbalance 334 and an insertion loss 336 within a hybrid coupler (e.g., hybrid coupler 100) with respect to a frequency 332 of an input RF signal (e.g., input RF signal 220, 222a, 222b) is provided.

As depicted in FIG. 3, the amplitude imbalance curve 337 is at a minimum amplitude imbalance 338 at or near a center frequency 333. An amplitude imbalance is a difference in amplitude of the electromagnetic signal on the two transmission lines of the hybrid coupler. For example, an amplitude imbalance may be the difference in amplitude of the RF signal at the first output port (e.g., output port 100c) and the second output port (e.g., output port 100d) in an instance in which the hybrid coupler is in a power divider mode. The smaller the amplitude imbalance, the better the usage. In some embodiments, the bandwidth of the hybrid coupler may be determined based on the amplitude imbalance at various frequencies. For example, utilizing a commonly accepted threshold of amplitude imbalance of 1 dB. Although the hybrid coupler may operate at frequencies with an amplitude imbalance greater than 1 dB, the 1 dB frequency provides an indicator of the hybrid coupler frequency bandwidth.

An amplitude imbalance at or near 0 indicates the electromagnetic signal on the two transmission lines within the hybrid coupler are equally or quasi-equally balanced. As depicted in FIG. 3, the amplitude imbalance is at a minimum amplitude imbalance 338 at or near 0 in an instance in which the input RF signal (e.g., input RF signal 220, 222a, 222b) is transmitted at a center frequency 333. Deviation of a few gigahertz in either direction leads to an amplitude imbalance greater than 1 dB. The amplitude imbalance of a hybrid coupler may significantly limit the bandwidth of a hybrid coupler. For example, in some embodiments, the bandwidth is limited to only those frequencies for which the amplitude imbalance is less than 1 dB.

As further depicted in FIG. 3, the insertion loss curve 339 depicts insertion losses when referring to an input RF signal (e.g., input RF signal 220, which shows on the respective signals 220a, 220b) losses called insertion losses, within the circuitry of the hybrid coupler. As depicted in FIG. 3, the insertion loss curve 339 depicts insertion losses across a wide frequency bandwidth. The insertion loss of a hybrid coupler may further define the bandwidth of a hybrid coupler. For example, in some embodiments, the bandwidth is limited to only those frequencies for which the insertion loss is less than 3 dB.

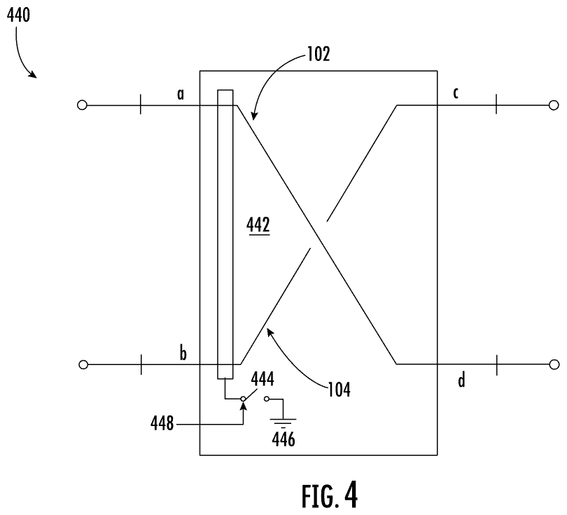

Referring now to FIG. 4, an example hybrid coupler 440 in accordance with an example embodiment of the present disclosure is provided. As depicted in FIG. 4, the example hybrid coupler 440 includes a transmission line 102 configured to transmit an electromagnetic signal from an input port 440a to an output port 440d of the hybrid coupler 440. The hybrid coupler 440 further includes a transmission line 104 configured to transmit an electromagnetic signal from an input port 440b to an output port 440c of the hybrid coupler 440. For each of the transmission lines 102, 104, there is a certain dielectric material with a given dielectric constant defining a tuning equivalent capacitance between the transmission line 102, 104 and a reference ground plane. A conductive strip 442 is positioned proximate the transmission lines 102, 104 altering the dielectric constant and thus the tuning equivalent capacitance between the respective transmission lines 102, 104 and the respective reference ground plane 446. As further depicted in FIG. 4, the hybrid coupler 440 includes a switch 444 connected to the conductive strip 442 at one end and electrically connected to a ground plane 446 at the other end. A control signal 448 is configured to control the state of the switch 444.

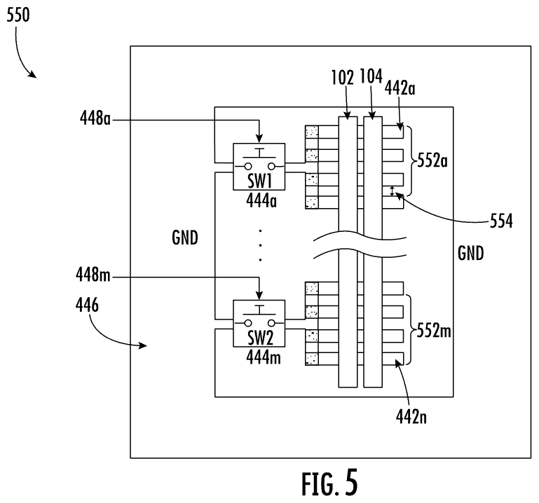

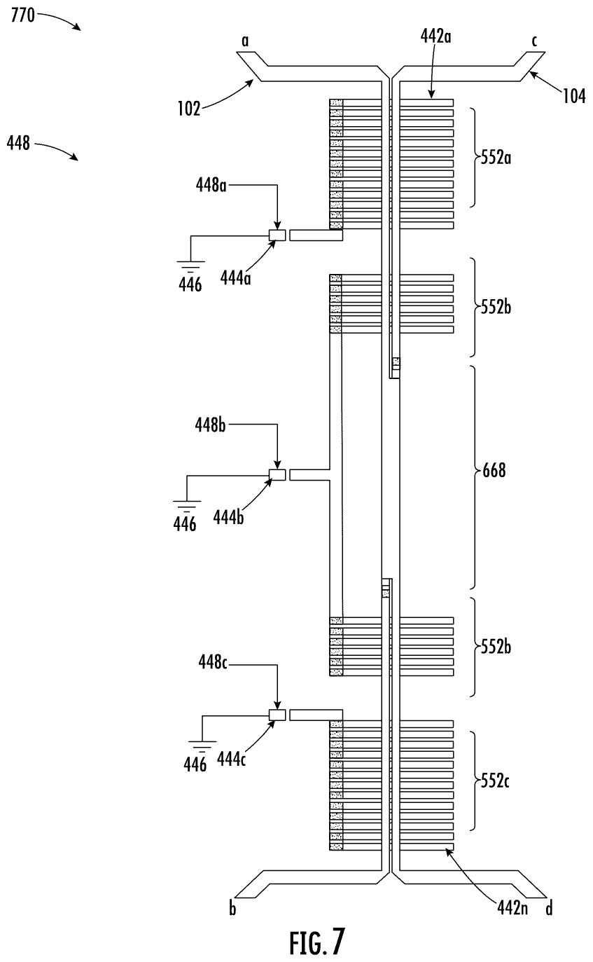

As depicted in FIG. 4, the hybrid coupler 440 includes a conductive strip 442. A conductive strip 442 is any conductive material, such as a metal trace, which is positioned in close proximity without contacting the transmission lines 102, 104 of the hybrid coupler 440. For each of the transmission lines 102, 104, there is a certain dielectric constant between the transmission line 102, 104 and a reference ground plane. Placing the conductive strip 442 in close proximity without contacting the transmission lines 102, 104 defines a dielectric gap between the conductive strip 442 and the transmission lines 102, 104. In an instance in which the conductive strip 442 is electrically connected to a ground plane 446, the conductive strip 442 alters the dielectric constant between the respective transmission lines 102, 104 and the reference ground plane 446. The capacitance created between the conductive strip 442 and the transmission lines 102, 104 and defined by the dielectric constant between the transmission lines 102, 104 and the ground plane 446 may be referred to as a tuning equivalent capacitance. As an example, in the case the switch 444 is in an open state, the conductive strip 442 is electrically floating (e.g., not connected to any electrical potential). In such a case, two capacitors in series appear: one between the transmission lines 102, 104 and the conductive strip 442, and another one between the conductive strip 442 and the ground plane 446. Two capacitors in series will give a smaller overall capacitance (e.g., tuning equivalent capacitance) than the one capacitor in the case in which the switch 444 is closed and conductive strip 442 is connected to the ground plane 446. The tuning equivalent capacitance may be dependent on the size of the conductive strip 442 (e.g., length, width, thickness), the material comprising the conductive strip 442 (e.g., copper, aluminum, tin, gold), the width of the dielectric gap between the conductive strip 442 and the transmission line 102, 103, the number of conductive strips 442, and so on. FIG. 5 and FIG. 7 depict embodiments comprising a plurality of conductive strips 442.

A hybrid coupler 440 may be associated with a center frequency. The center frequency is the frequency of the electromagnetic signal transmitted through the hybrid coupler 440 at which the amplitude imbalance of the electromagnetic signals in the separate transmission lines 102, 104 is equal to zero. As further described in relation to FIG. 5, the center frequency of the hybrid coupler 440 may be inversely proportional to the tuning equivalent capacitance in the hybrid coupler 440. For example, an increase in tuning equivalent capacitance on a transmission line 102, 104 in the hybrid coupler 440 may decrease the center frequency of the hybrid coupler 440.

As further depicted in FIG. 4, the example hybrid coupler 440 includes a switch 444. A switch 444 is any electrical component configured to selectively enable and disable electric flow through the component. For example, a switch 444 may be a transistor device. A switch 444 may comprise various switch states. For example, in a closed switch state, the switch 444 may enable electrical flow from a first portion of the switch 444 (e.g., first terminal) to a second portion of the switch 444 (e.g., second terminal). In an open switch state, the switch 444 may prevent electrical flow from the first terminal to the second terminal.

As further depicted in FIG. 4, the switch state of the switch 444 may be updated based on one or more control signals 448. A control signal 448 is any electromagnetic wave configured to communicate the state of the switch 444. The control signal 448 may be a direct current (DC) voltage and the switch state may be determined based on the amplitude of the DC voltage. For example, in an NMOS transistor configuration, a logically low voltage (e.g., 0 volts) may force the switch into a closed switch state. Alternatively, a logically high voltage (e.g., 1.8 volts) may force the switch into an open switch state. Thus, a controller or other electronic device may define the state of the switch by transmitting a control signal 448.

As further depicted in FIG. 4, a first terminal of the switch 444 is electrically connected to the conductive strip 442 and a second terminal of the switch 444 is electrically connected to a ground plane 446. In an instance in which the switch 444 is in a closed switch state, the conductive strip 442 is electrically connected to the ground plane 446. In such an instance, the equivalent dielectric constant (or, better said in physical terms: the distance between the two electrodes of the capacitance is altered) between the transmission lines 102, 104 and the ground plane 446 is altered, altering the tuning equivalent capacitance between the conductive strip 442 and the transmission lines 102, 104. Alternatively, in an instance in which the switch 444 is in an open switch state, the conductive strip 442 is kept floating. In such an instance, the tuning equivalent capacitance present between the conductive strip 442 and the transmission lines 102, 104 is reduced. Thus, the control signal 448 may be utilized to selectively change the switch state of the switch 444 between an open switch state and a closed switch state. Altering the switch state further alters the tuning equivalent capacitance between the ground plane 446 and the transmission lines 102, 104. Altering the tuning equivalent capacitance adjusts the center frequency of the hybrid coupler 440, enabling the hybrid coupler 440 to efficiently operate at a new center frequency and effectively increasing the bandwidth of the hybrid coupler 440. By adjusting the tuning equivalent capacitance based on the received RF input signal at the hybrid coupler 440, a hybrid coupler 440 may be tuned to the specific frequency of the RF input signal.

Referring now to FIG. 5, an example hybrid coupler 550 comprising a plurality of conductive strips 442a-442n is depicted. As depicted in FIG. 5, the plurality of conductive strips 442a-442n are positioned proximate the transmission lines 102, 104. In addition, the hybrid coupler 550 includes a plurality of switches 444a-444m. Each switch 444a-444m is electrically connected to a subset of conductive strips 552a-552m at one terminal, and electrically connected to a ground plane 446 at the other terminal. As further depicted in FIG. 5, each switch 444a-444m is configured by a control signal 448a-448m.

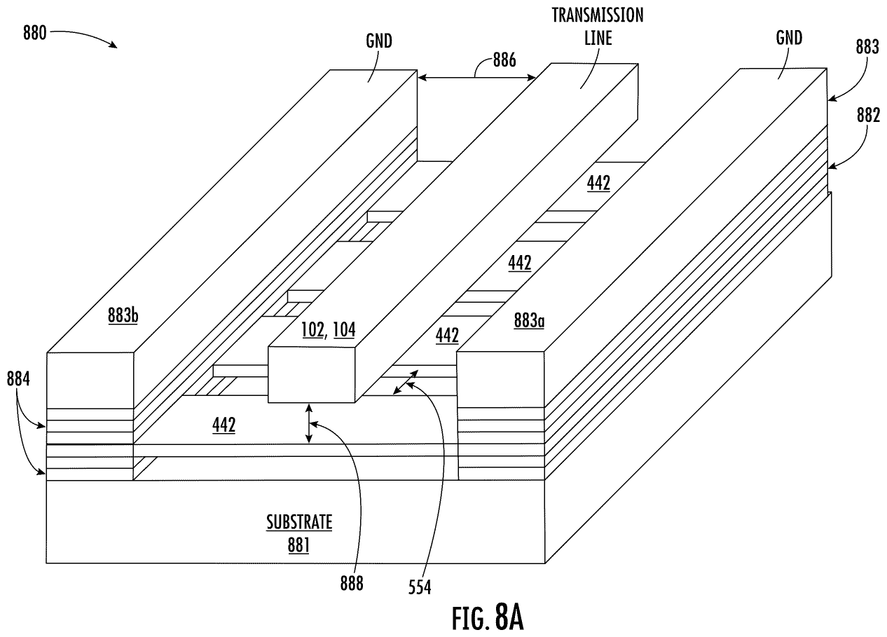

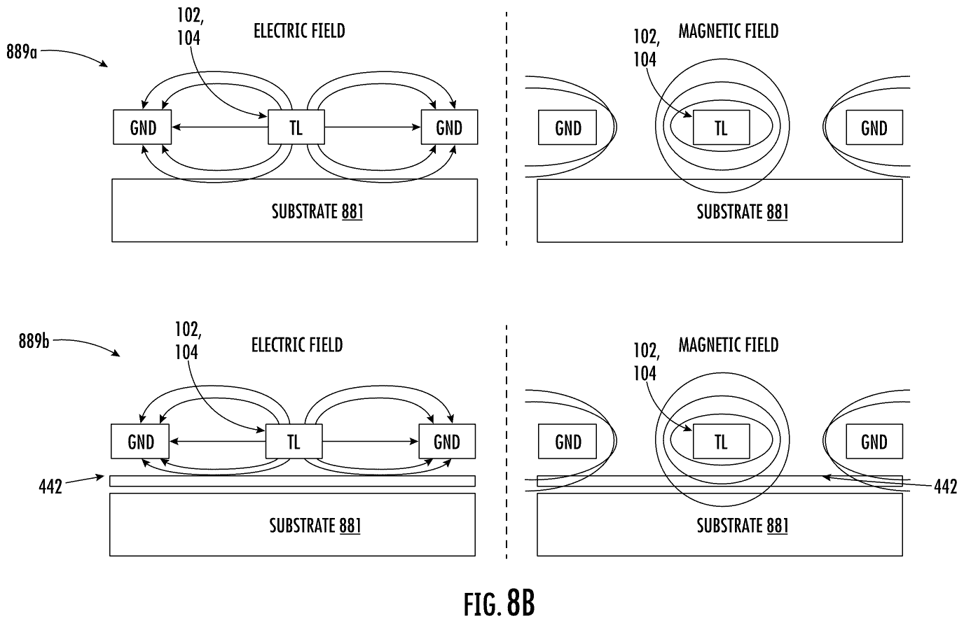

As depicted in FIG. 5, the hybrid coupler 550 may include a plurality of conductive strips 442a-442n positioned proximate the transmission lines 102, 104, each with a dielectric gap between the conductive strip 442a-442n and the transmission line 102, 104 creating an equivalent dielectric constant between the transmission line 102, 104 and a ground plane 446 contributing to the tuning equivalent capacitance of the transmission line 102, 104. Each conductive strip 442a-442n, when electrically connected to the ground plane 446 alters the equivalent dielectric constant between the transmission line 102, 104 and the ground plane 446 by grounding the conductive strip 442a-442n. Each capacitance attributable to each conductive strip 442a-442n is added in parallel to generate the tuning equivalent capacitance across the transmission lines 102, 104. Thus, the tuning equivalent capacitance is proportional to the number of conductive strips 442a-442n that are grounded during operation. The center frequency is also altered based on the change in the tuning equivalent capacitance. Indeed, the tuning equivalent capacitance is inversely proportional to the tuning equivalent capacitance along the transmission line. As the tuning equivalent capacitance increases, the center frequency of the hybrid coupler 550 is reduced. Similarly, as the tuning equivalent capacitance decreases, the center frequency of the hybrid coupler 550 is increased. In some embodiments, the center frequency (fo) may be determined by the equation:

$${f}_{0} = \frac{( 2 - k )}{2 π \sqrt{2 L {C}_{tune}}}$$

where k is the coupling coefficient of the two transmission lines 102 and 104 when no metallic strips are placed in vicinity, L is the equivalent inductance of the hybrid coupler 550, and Cₜᵤₙₑ is the tuning equivalent capacitance along the transmission line 102, 104. In addition, each of the conductive strips 442 are separated by a spacing distance 554 in accordance with slow wave principles (e.g., a spacing distance less 554 less than or equal to a dielectric gap 888). The spacing distance 554 is configured to alter the electric field of the transmission lines 102, 104 while leaving the magnetic field substantially unaltered. In order to operate in accordance with slow wave principles, the spacing distance 554 must remain smaller than or equal to the dielectric gap 888 between the conductive strips 442 and the transmission lines 102, 104. The relationship of the dielectric gap to the spacing distance 554 is further described in relation to FIG. 8A.

As further depicted in FIG. 5, the conductive strips 442a-442n are grouped into a subset of conductive strips 552a-552m. A subset of conductive strips 552a-552m is any grouping of conductive strips 442a-442n comprising one or more conductive strips 442a-442n and coupled to a switch 444a-444m providing a selective electrical coupling to a ground plane 446. In some embodiments, a subset of conductive strips 552a-552m may comprise a variable number of conductive strips 442a-442n. For example, a first subset of conductive strips 552a-552m may comprise two conductive strips 442a-442n, a second subset of conductive strips 552a-552m may comprise five conductive strips 442a-442n, and so on. The number of conductive strips 442a-442n in a subset of conductive strips 552a-552m may be selected based on the desired precision and range of the tuning equivalent capacitance and center frequency for the hybrid coupler 550.

As further depicted in FIG. 5, each subset of conductive strips 552a-552m may be enabled by setting the switch state of the switch 444a-444m corresponding to the subset of conductive strips 552a-552m to a closed switch state. Similarly, each subset of conductive strips 552a-552m may be disabled by setting the switch state of the switch 444a-444m corresponding to the subset of conductive strips 552a-552m to an open switch state. In the case a switch 444a-444m is in an open state, the corresponding conductive strips in the respective subset of conductive strips 552a-552m are electrically floating (e.g., not connected to any electrical potential). In such a case, two capacitors in series appear: one between the transmission lines 102, 104 and the conductive strips within the respective subset of conductive strips 552a-552m, and another one between the conductive strips and the ground plane 446. Two capacitors in series will give a smaller overall capacitance (e.g., tuning equivalent capacitance) than the one capacitor in the case in which a switch 444a-444m is closed and the conductive strips corresponding to the subset of conductive strips 552a-552m are connected to the ground plane 446. For example, by setting the switch state of the switch 444a to closed, each of the conductive strips in the subset of conductive strips 552a are electrically connected to the ground plane 446 and the overall tuning equivalent capacitance is increased. As depicted in FIG. 5, each of the control signals 448a-448m may be utilized to update the switch state of each corresponding switch 444a-444m.

By selectively enabling and disabling each of the subsets of conductive strips 552a-552m, the tuning equivalent capacitance of the hybrid coupler 550 may be continually updated based on the frequency of the input RF signal. Thus, the tuning equivalent capacitance of the hybrid coupler may be tuned to a center frequency minimizing the amplitude imbalance of the input RF signal, effectively increasing the bandwidth of the hybrid coupler 550.

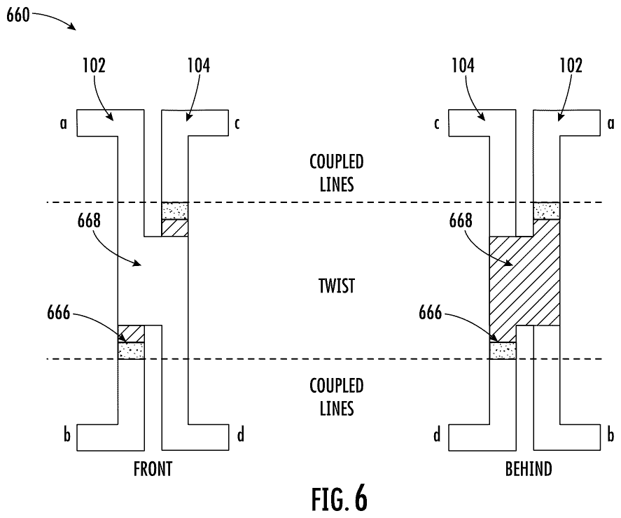

Referring now to FIG. 6, an example twisted hybrid coupler 660 is provided. As shown in FIG. 6, the example twisted hybrid coupler 660 includes a first transmission line 102 and a second transmission line 104. The first transmission line 102 is overlaid over a portion of the second transmission line 104 in a crossing region 668. A twisted hybrid coupler 660 such as that depicted in FIG. 6 may provide adequate coupling with minimal insertion losses in a compact design.

As depicted in FIG. 6, the twisted hybrid coupler 660 may be manufactured in a stacked architecture. A stacked architecture is any architecture that includes a substrate and various elements of a hybrid coupler (e.g., hybrid coupler 660) disposed on various metallic layers of the stacked architecture, separated one from the other by a dielectric layer. For example, a stacked architecture may include a monolithic architecture in which all the components of the hybrid coupler are integrated on a single integrated circuit. In addition, a stacked architecture hybrid coupler may be implemented on a printed circuit board (PCB). In some embodiments, various components of the hybrid coupler may be disposed on separate electrical components. For example, a controller configured to generate the control signal (e.g., control signal 448) may be disposed on an electrical component separate from the hybrid coupler. FIG. 6-FIG. 8A include various stacked architectures of hybrid couplers.

The transmission line 104 as depicted in FIG. 6 is disposed on multiple layers of the stacked architecture. At the crossing region 668, the transmission line 104 transitions to a layer below the transmission line 102. The transition is accomplished through vias 666. Through the crossing region 668, a gap remains between the transmission line 102 and the transmission line 104. In any case, there is no electrical contact between the first transmission line 102 and the second transmission line 104.

Referring now to FIG. 7, an example twisted hybrid coupler 770 designed in a stacked architecture and comprising a plurality of subsets of conductive strips 552a-552c is provided. As depicted in FIG. 7, the example twisted hybrid coupler 770 includes a first transmission line 102 providing a conductive path from the input port 770a to the output port 770d. The example twisted hybrid coupler 770 further includes a second transmission line 104 providing a conductive path from the input port 770b to the output port 770c. At the crossing region 668, the second transmission line 104 passes under the first transmission line 102. As further depicted in FIG. 7, the twisted hybrid coupler 770 includes a plurality of conductive strips 442a-442n separated from the transmission lines 102, 104 by a dielectric gap, and grouped in three subsets of conductive strips 552a, 552b, and 552c. Each subset of conductive strips 552a-552c are electrically connected to a corresponding switch 444a-444c which provides an electrical connection to a ground plane 446 in an instance in which the switch 444a-444c is in a closed state. As further depicted in FIG. 7, each of the switches 444a-444c are controlled by a corresponding control signal 448a-448c.

As depicted in FIG. 7, the twisted hybrid coupler 770 includes three subsets of conductive strips 552a, 552b, 552c each comprising a plurality of conductive strips 442a-442n. The number of conductive strips 442a-442n, the physical dimensions of the conductive strips 442a-442n, and the size of the dielectric gap between the conductive strips 442a-442n and the transmission lines 102, 104 all effect the increase in tuning equivalent capacitance occurring in an instance in which a switch 444a-444c is closed and the corresponding conductive strips 442a-442d are grounded. Although, as depicted in FIG. 7, the conductive strips 442a-442n are proximate to the transmission lines 102, 104 only outside of the crossing region 668, the conductive strips 442a-442d may be positioned proximate the transmission lines 102, 104 anywhere along the transmission lines 102, 104.

As further depicted in FIG. 7, each subset of conductive strips 552a-552c may be selectively grounded and ungrounded by switching the state of the corresponding switch 444a-444c between a closed switch state and an open switch state. In some embodiments, the update of the switch state of each switch 444a-444c may be determined by a control signal 448a-448c. For example, as depicted in FIG. 7, the control signals 448a-448c may be defined by a three-bit data signal where each bit of the data signal corresponds to a switch state of a switch 444a-444c. In such an example, such as with NMOS switches, a logic 1 may represent a closed switch state and a logic 0 may represent an open switch state. In addition, each bit of the data signal may correspond to a control signal 448a-448c of each switch 444a-444c. For example, bit 0 of the data signal may dictate the value of control signal 448a and the resulting state of the first switch 444a, bit 1 of the data signal may dictate the value of control signal 448b and the resulting state of the second switch 444b, and bit 2 of the data signal may dictate the value of control signal 448c and the resulting state of the third switch 444c. Thus, a 3-bit data signal of ‘001’ may cause the first switch 444a and the second switch 444b to be open, while the third switch 444c is closed. Closing the third switch 444c grounds the conductive strips in the corresponding subset of conductive strips 552c. In this scenario, the capacitance of each of the conductive strips and the transmission lines 102, 104, in the subset of conductive strips 552c is altered, effectively increasing the overall tuning equivalent capacitance. Similarly, a 3-bit control signal of ‘110’ may cause the first switch 444a and the second switch 444b to be closed, while the third switch 444c is open. Closing the first and second switches 444a, 444b grounds the conductive strips in the corresponding subsets of conductive strips 552a, 552b, increasing the capacitance between the transmission lines 102, 104 and the ground plane. In this scenario, the tuning equivalent capacitance is defined by the increased capacitance created by each of the conductive strips in the subset of conductive strips 552a and the increased capacitance created by each of the conductive strips in the subset of conductive strips 552b. As can be seen, eight different capacitive states may be defined by grouping three different subsets of conductive strips 552a-552c. In some examples, each capacitive state may represent a different center frequency of the hybrid coupler 770, thus, effectively increasing the bandwidth of the hybrid coupler 770.

Referring now to FIG. 8A, an example stacked architecture 880 of a transmission line 102, or transmission line 104 respectively comprising a plurality of conductive strips 442 proximate the transmission line 102, 104 is depicted. As depicted in FIG. 8A, the stacked architecture 880 includes a substrate layer 881. Stacked on the substrate layer 881 is one or more dielectric layers 884. The conductive strips 442 are disposed on a metallic layer 882 below a transmission line in a layer 883 and separated from the transmission line 883 by one or more dielectric layers 884 creating a dielectric gap 888 between the transmission line 102, 104 and the conductive strips 442. Although not pictured, the dielectric layers 884 are also used to separate the transmission line 102, 104 from the conductive strips 442 and the substrate 881 respectively.

As depicted in FIG. 8A, the transmission layer 883 defines a coplanar waveguide including the transmission line 102, 104 with a pair of grounded conductors 883a, 883b within the same plane on either side of the transmission line 102, 104 and separated by a separation gap 886 from the transmission line 102, 104. A coplanar waveguide may be utilized based on a number of advantages provided when transmitting electromagnetic signals through a hybrid coupler. For example, a coplanar waveguide provides better isolation of the transmission line 102, 104 from nearby transmissions. In addition, a coplanar waveguide may reduce radiation loss and provide for utilization over a wide bandwidth.

As further depicted in FIG. 8A, the conductive strips 442 may be positioned proximate the transmission line 102, 104 of the coplanar waveguide. As shown in FIG. 8A, the conductive strips 442 are positioned orthogonal to the transmission line 102, 104 with at least one dielectric layer 884 positioned between the transmission line 102, 104 and the conductive strips 442. The dielectric layers 884 electrically insulate the conductive strips 442 from the transmission line 102, 104. In addition, the conductive strips 442 are electrically insulated from the substrate 881 except when electrically connected to the ground plane in an instance in which a switch (e.g., switch 444) is in a closed state.

The dielectric layer 884 defines a dielectric gap 888 having a defined height between the conductive strips 442 and the transmission line 102, 104. Although not limiting, in some embodiments, the dielectric gap 888 may be equal to one or more back end of line layer heights. The dielectric gap 888 creates a first equivalent capacitance between the transmission line 102, 104 and a reference ground plane in an instance in which the conductive strips 442 are electrically floating (e.g., a capacitance between the transmission line 102, 104 and the conductive strip 442 in series with a capacitance between the conductive strip and the reference ground plane). The dielectric gap 888 creates a second capacitance between the transmission line 102, 104 and the reference ground plane in an instance in which the conductive strips 442 are connected to the reference ground plane (e.g., a capacitance between the transmission line 102, 104 and the grounded conductive strip 442).

In addition, each of the conductive strips 442 are separated by a spacing distance 554. In order to operate in accordance with slow wave principles, the spacing distance 554 must remain smaller or similar than the dielectric gap 888.

FIG. 8B illustrates the electric field and magnetic field of an example transmission line 102, 104. In the depiction 889a, the electric field and magnetic field are depicted without a conductive strip 442 proximate the transmission line 102, 104. In the depiction 889b, the electric field and magnetic field are depicted in an instance in which a conductive strip 442 is positioned proximate the transmission line 102, 104. As compared to the depiction 889a, there is no substantial change in the magnetic field in an instance in which a conductive strip 442 is placed proximate the transmission line 102, 104. However, the electric field is altered by the presence of the conductive strip 442 proximate the transmission line. This slow wave effect is due to slow wave principles defining the spacing distance 554 between the conductive strips 442 relative to the dielectric gap 888.

In an instance in which the spacing distance 554 between the conductive strips 442 remains smaller than or similar to the dielectric gap 888 between the transmission line 102, 104 and the conductive strips 442, a shielding effect is created that prevents the electric field from penetrating the substrate 881. By preventing the electric field from penetrating the substrate 881, an increase in linear capacitance (e.g., tuning equivalent capacitance) due to the added capacitive effect between the transmission line 102, 104 and the conductive strips 442 is obtained. In addition, the spacing distance 554 between the conductive strips 442 allows the magnetic field to pass through the substrate 881, enabling the value of the linear inductance of a coplanar waveguide to be maintained.

Further, the dielectric gap 888 alters an equivalent capacitance between the transmission line 102, 104 and each grounded conductive strip 442. The increased capacitance works to decrease the phase velocity of the electromagnetic signal passing through the transmission line 102, 104 and subsequently decrease the center frequency of a hybrid coupler comprising the transmission line 102, 104. The capacitance altered by each conductive strip 442 may depend on the size of the dielectric gap 888, the dielectric material between the conductive strips 442 and the transmission line 102, 104, the physical characteristics of the conductive strips 442, and so on. Although depicted under the transmission line 102, 104, in some embodiments, the conductive strips 442 may be positioned above the transmission line 102, 104 in a stacked architecture 880.

As further depicted in FIG. 8A, the stacked architecture 880 includes a substrate layer 881. The substrate layer 881 is any structure layer to which the components of the electrical component may be rigidly attached and further capable of routing electronic signals within and/or to/from the electrical component. In some embodiments, the substrate layer may comprise a PCB. A PCB may be utilized to mount and interconnect various electrical components of an electronic system. In some embodiments, various components of a hybrid coupler may be located at various positions on a substrate layer 881. For example, a processor configured to generate the control signals may be remote from the hybrid coupler and configured to transmit the control signal to the hybrid coupler.

In some embodiments, the substrate layer 881 may define a monolithic integrated circuit. In such an embodiment, the substrate layer 881 may comprise a semiconductor material utilized as the base for defining various electrical features, for example, the electrical features comprising a hybrid coupler.

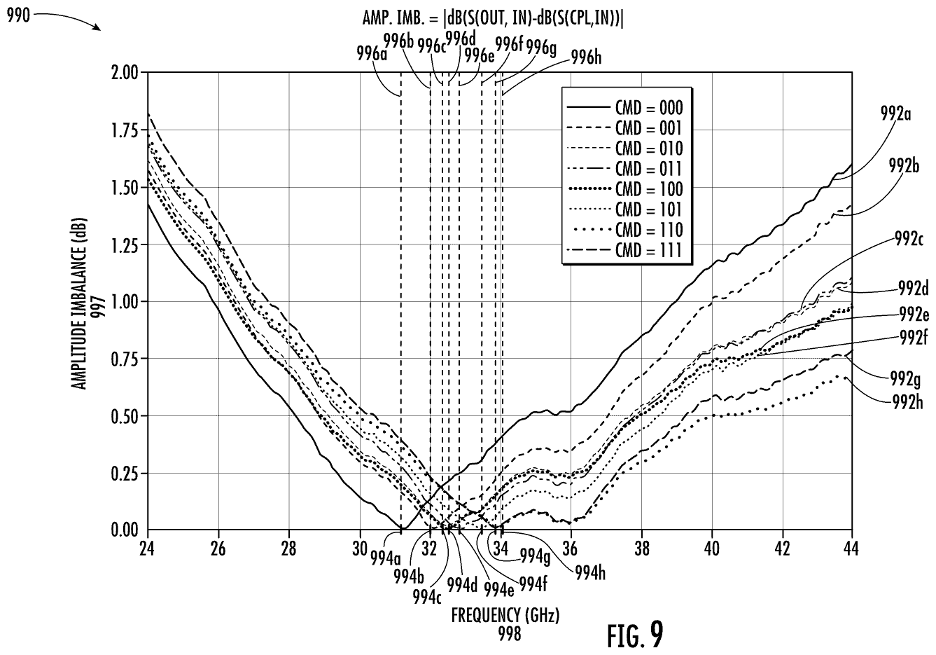

Referring now to FIG. 9, an example graph 990 is provided. The graph 990 depicts the amplitude imbalance 997 of various configurations of a hybrid coupler (e.g., hybrid coupler 770) in accordance with the present disclosure.

As depicted in FIG. 9, each curve 992a-992h represents the result of the usage of different configurations of the subsets of conductive strips (e.g., subset of conductive strips 552a-552m) of a hybrid coupler. The example graph 990 of FIG. 9 depicts example amplitude imbalances 997 for a hybrid coupler comprising three subsets of conductive strips for a total of eight different configurations. As described herein, each state of the hybrid coupler may induce a different tuning equivalent capacitance on the transmission line (e.g., transmission line 102, 104) of the hybrid coupler. Further, a change in tuning frequency further affects the center frequency of the hybrid coupler. As depicted in graph 990, the center frequency 996a-996h of the hybrid coupler and thus the minimum amplitude imbalance 994a-994h is updated with each state. As can be seen on the graph 990, various states of the subset of conductive strips may be selected such that the amplitude imbalance remains below 1 dB from 26 GHz to greater than 44 GHz. The bandwidth of the hybrid coupler may be directly related to an amplitude imbalance less than 1 dB. For example, in some embodiments, the 1 dB relative bandwidth of the hybrid coupler in accordance with one or more embodiments of the present disclosure may exceed 40%.

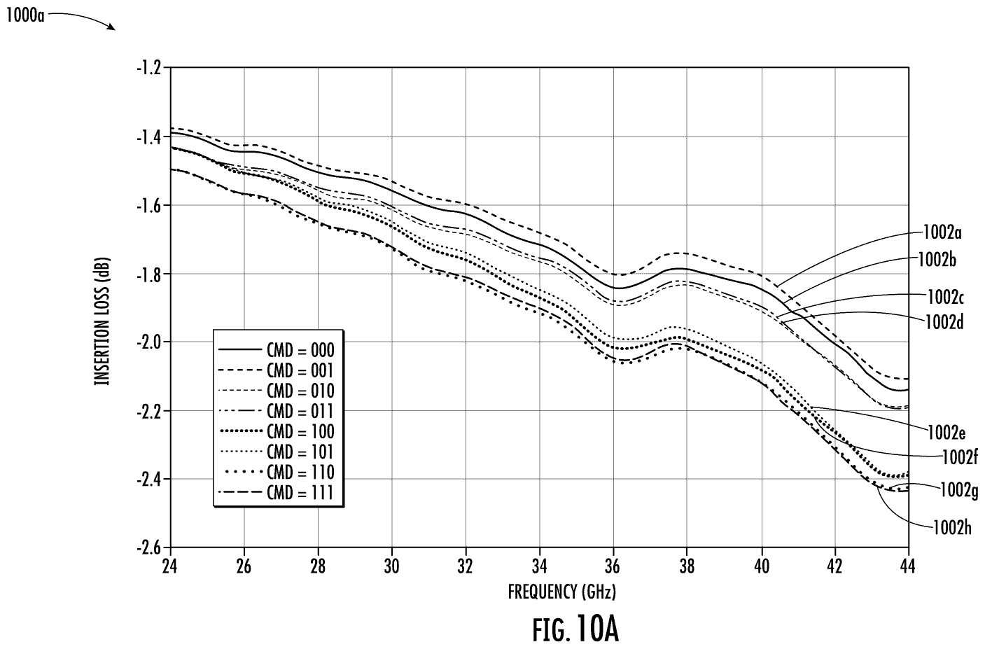

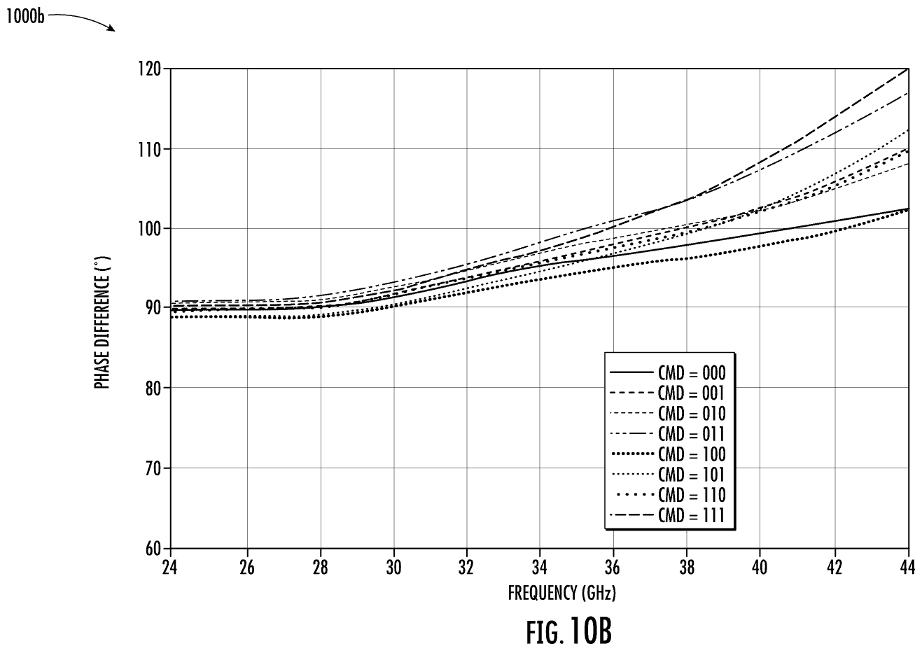

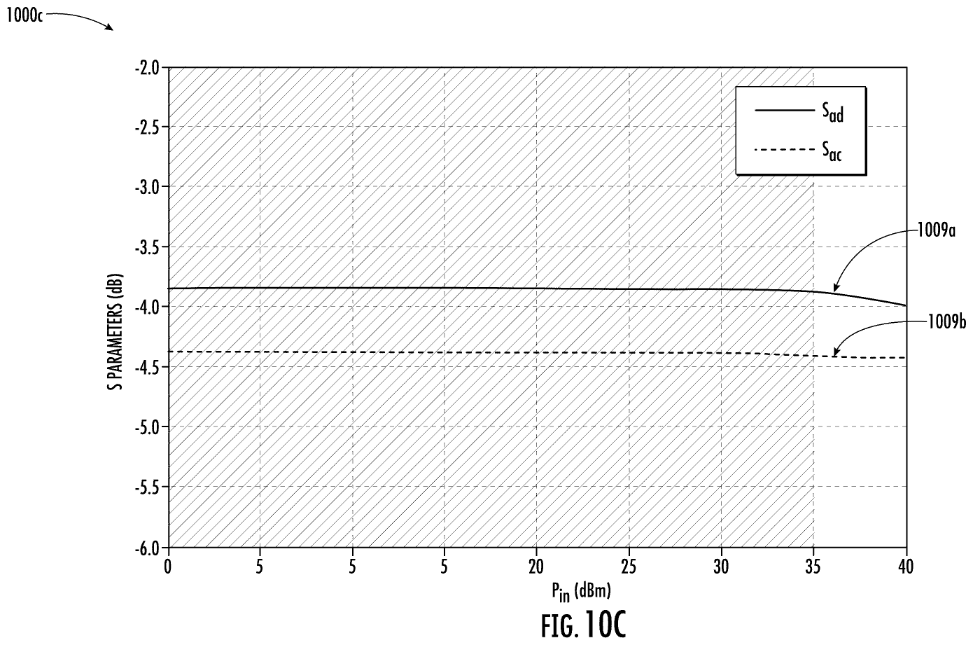

Referring now to FIG. 10A, an example graph 1000 is provided. The graph 1000 depicts the insertion loss of various configurations of a hybrid coupler (e.g., hybrid coupler 770) in accordance with the present disclosure. The insertion loss value is calculated as the average between the insertion loss on line 102 and the insertion loss on line 104.

As depicted in FIG. 10A, each curve 1002a-1002h represents a configuration of the subsets of conductive strips (e.g., subset of conductive strips 552a-552m) of a hybrid coupler. The example graph 1000 of FIG. 10A depicts example insertion losses for a hybrid coupler comprising three subsets of conductive strips for a total of eight different configurations. In general, as the frequency of the RF signal traveling through the hybrid coupler increases, so does the insertion losses. However, as depicted in FIG. 10A, the insertion losses may remain less than 2.5 decibels even as the frequency of the RF signal increases to 44 GHz.

Referring now to FIG. 10B, a graph 1000b depicting example phase differences) (°) between two outputs (e.g., output 770c, 770d) with respect to an input signal frequency (GHz) for various switch configurations of a hybrid coupler (e.g., hybrid coupler 770) are provided. As depicted in FIG. 10B, the selection of states may enable the phase imbalance between the two outputs to be minimized for a wide frequency bandwidth. For example, switch states of ‘000’ and ‘100’ may be selected at frequencies above 38 gigahertz to minimize the unwanted phase difference and increase the efficiency of the example hybrid coupler across a wide range of frequencies.

Referring now to FIG. 10C, a graph 1000c depicting example insertion loss (S Parameters) curves 1009a, 1009b with respect to an input power (Pᵢₙ) are provided. The transmission parameters depict insertion losses through various paths of an example hybrid coupler (e.g., hybrid coupler 100, 440, 550, 770, 880). The insertion loss curve 1009a depicts the insertion loss from the input port 100a, 440a, 550a, 770a, 880a to the output port 100d, 440d, 550d, 770d, 880d. Similarly, the insertion loss curve 1009b depicts the insertion loss from the input port 100a, 440a, 550a, 770a, 880a to the output port 100c, 440c, 550c, 770c, 880c. As depicted in FIG. 10C, the transmission parameters 1009a, 1009b demonstrate linear operation up to 35 dBm because principally of the passive nature of the coupler and, as a secondary feature, having the switches aside of the direct transmission path enable the usage of large and linear switches (for example NMOS transistors).

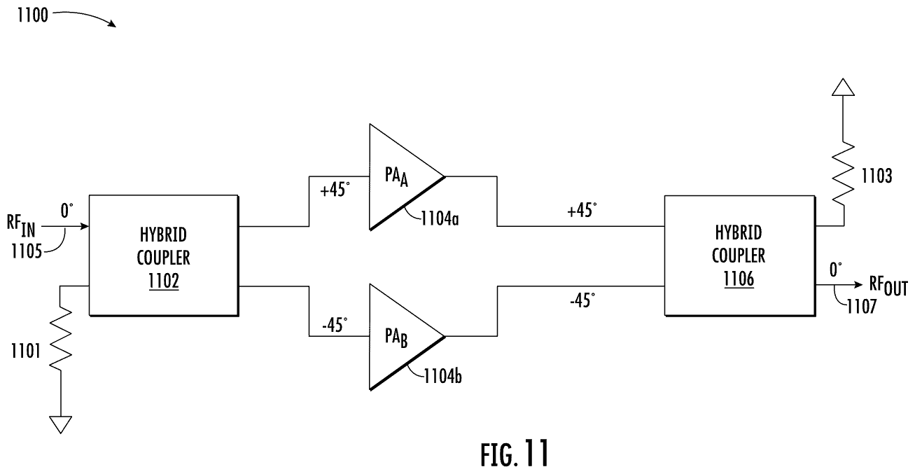

Referring now to FIG. 11, an example power amplifying circuit 1100 comprising a pair of hybrid couplers 1102, 1106, in accordance with one or more embodiments of the present disclosure, is provided. As depicted in FIG. 11, the example power amplifying circuit 1100 comprises a balanced architecture. The example power amplifying circuit 1100 includes an input hybrid coupler 1102 (e.g., hybrid coupler 440, 550, 770) with two inputs and two outputs. An input RF signal is transmitted to the input hybrid coupler 1102 on a first input. The second input is electrically connected to a ballast resistor 1101, such that the hybrid coupler 1102 is configured in a power divider mode.

As further depicted in FIG. 11, the first output of the input hybrid coupler 1102 is electrically connected to the input of a first amplifier 1104a. Similarly, the second output of the input hybrid coupler 1102 is electrically connected to the input of a second amplifier 1104b. As further depicted in FIG. 11, the example power amplifying circuit 1100 includes an output hybrid coupler 1106 (e.g., hybrid coupler 440, 550, 770) also having two inputs and two outputs. The first input of the output hybrid coupler 1106 is electrically connected to the output of the first amplifier 1104a. Similarly, the second input of the output hybrid coupler 1106 is electrically connected to the output of the second amplifier 1104b. The isolation output of the second hybrid coupler 1106 is electrically connected to a load resistor 1103, such that the hybrid coupler 1106 is configured in a power combiner mode. The second output is configured to generate the RF output signal which may be transmitted on an antenna in a wireless network.

The balanced architecture of the example power amplifying circuit 1100 provides robustness to variations in VSWR and linear amplification of input RF signals. Utilizing hybrid couplers 1102, 1106 with a central frequency that is reconfigurable based on enabling and disabling conductive strips (e.g., conductive strips 442) enables the balanced power amplifying circuit 1100 to operate over a wide frequency bandwidth with minimal insertion losses. Utilizing a twisted hybrid coupler further reduces the area occupied by a hybrid coupler 1102, 1106 in a power amplifying circuit 1100.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that utilizes a hybrid coupler across a wide bandwidth of frequencies. For example, mobile phones, laptops, computers, tablets, gaming systems, virtual reality and/or augmented reality systems, internet modems, automobiles, unmanned aerial vehicles, sensors, robotic devices, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A hybrid coupler, comprising:
two or more transmission lines,
wherein at least one transmission line of the two or more transmission lines is configured to transmit an electromagnetic signal from an input port to an output port,
wherein a phase shift is adapted to be applied to at least a portion of the electromagnetic signal;
a plurality of conductive strips positioned proximate to the at least one transmission line,
wherein each conductive strip of the plurality of conductive strips alters a tuning equivalent capacitance between the at least one transmission line and a reference ground plane;
wherein at least a spacing distance separates each conductive strip in the plurality of conductive strips,
wherein at least a dielectric gap separates each conductive strip in the plurality of conductive strips from the at least one transmission line, and
wherein the spacing distance is smaller than the dielectric gap or similar; and
a switch electrically connected to each conductive strip of the plurality of conductive strips and the reference ground plane;
wherein the tuning equivalent capacitance between the at least one transmission line and the ground plane is adapted based on a state of the switch, and
wherein a change in the tuning equivalent capacitance is adapted to change a center frequency of the hybrid coupler.

2. The hybrid coupler of claim 1, wherein the switch is electrically connected to a plurality of conductive strips, and wherein the tuning equivalent capacitance is correlated with a number of conductive strips in the plurality of conductive strips.

3. The hybrid coupler of claim 2, comprising a plurality of switches, wherein each switch of the plurality of switches is electrically connected to a subset of the plurality of conductive strips.

4. The hybrid coupler of claim 3, wherein the tuning equivalent capacitance is adapted based on the state of each switch in the plurality of switches.

5. The hybrid coupler of claim 1, wherein the hybrid coupler further comprises:
a second input port; and
a second output port;
wherein the output port is electrically connected to the input port by a first transmission line, and
wherein the second output port is electrically connected to the second input port by a second transmission line.

6. The hybrid coupler of claim 5, comprising at least one crossing region in which the first transmission line and the second transmission line are overlaid.

7. The hybrid coupler of claim 5, wherein the hybrid coupler comprises a power combiner mode in which a first electromagnetic signal is received at the input port and a second electromagnetic signal is received at the second input port, and wherein the first electromagnetic signal and the second electromagnetic signal are combined at the output port.

8. The hybrid coupler of claim 5, wherein the hybrid coupler comprises a power divider mode in which a first electromagnetic signal is received at the input port, and wherein the first electromagnetic signal is divided into a first output signal at the output port and a second output signal at the second output port.

9. The hybrid coupler of claim 8, wherein an amplitude imbalance between the first output signal and the second output signal is at a minimum amplitude imbalance at the center frequency.

10. The hybrid coupler of claim 1, further comprising a coplanar waveguide, comprising:
the at least one transmission line, and
one or more coplanar return conductors parallel to the at least one transmission line;
wherein the one or more coplanar return conductors are separated from the at least one transmission line by a separation gap.

11. The hybrid coupler of claim 1, wherein a one decibel relative bandwidth is greater than 40%.

12. The hybrid coupler of claim 1, wherein an insertion loss is less than 2.5 decibels.

13. The hybrid coupler of claim 1, wherein the plurality of conductive strips are positioned orthogonal to the at least one transmission line.

14. A stacked architecture hybrid coupler comprising:
a substrate layer;
a transmission layer comprising two or more transmission lines, wherein at least one transmission line of the two or more transmission lines is configured to transmit an electromagnetic signal from an input port to an output port,
wherein a phase shift is adapted to be applied to at least a portion of the electromagnetic signal;
a metallic layer electrically insulated from the at least one transmission line and comprising a plurality of conductive strips, at least one conductive strip positioned proximate to the at least one transmission line,
wherein each conductive strip of the plurality of conductive strips alters a tuning equivalent capacitance between the at least one transmission line and a reference ground plane;
wherein at least a spacing distance separates each conductive strip in the plurality of conductive strips,
wherein at least a dielectric gap separates each conductive strip in the plurality of conductive strips from the at least one transmission line, and
wherein the spacing distance is smaller than the dielectric gap or similar; and
a switch electrically connected to each conductive strip of the plurality of conductive strips and the reference ground plane;
wherein the tuning equivalent capacitance between the at least one transmission line and the ground plane is adapted based on a state of the switch, and
wherein a change in the tuning equivalent capacitance is adapted to change a center frequency of the hybrid coupler.

15. The stacked architecture hybrid coupler of claim 14, wherein the metallic layer is positioned between the transmission layer and the substrate layer.

16. The stacked architecture hybrid coupler of claim 14, wherein the stacked architecture hybrid coupler comprises a monolithic integrated circuit.

17. The stacked architecture hybrid coupler of claim 14, wherein the substrate layer is part of a printed circuit board.

18. The stacked architecture hybrid coupler of claim 14, wherein the stacked architecture hybrid coupler comprises:
a second input port; and
a second output port;
wherein the output port is electrically connected to the input port by a first transmission line, and
wherein the second output port is electrically connected to the second input port by a second transmission line.

19. The stacked architecture hybrid coupler of claim 18, comprising at least one crossing region in which the first transmission line and the second transmission line are overlaid.

20. A power amplifying circuit, comprising:
a first hybrid coupler configured in a power divider mode, the first hybrid coupler comprising:
an input port configured to receive a first electromagnetic signal and divide the first electromagnetic signal into a first output signal on a first transmission line electrically connected to a first output port and a second output signal on a second transmission line electrically connected at a second output port,
wherein a phase shift is adapted to be applied between the first output signal and the second output signal;
a first conductive strip positioned proximate the first transmission line and the second transmission line, defining a first dielectric gap between each of the first transmission line and the second transmission line and the first conductive strip; and
a first switch electrically connected to the first conductive strip and a first electrical ground;
wherein a first tuning equivalent capacitance is adapted to be selectively generated between the first transmission line and the second transmission line and the first conductive strip based on a first switch state of the first switch;
a first amplifier configured to receive the first output signal and generate an amplified first signal;
a second amplifier configured to receive the second output signal and generate an amplified second signal; and
a second hybrid coupler configured in a power combiner mode, the second hybrid coupler comprising:
a first input port configured to receive the amplified first signal;
a second input port configured to receive the amplified second signal;
wherein the amplified first signal and the amplified second signal are combined in a combined transmission line at an output port, and
wherein the phase shift is applied between the amplified first signal and the amplified second signal;
a second conductive strip positioned proximate to the combined transmission line, defining a second dielectric gap between the combined transmission line and the second conductive strip; and
a second switch electrically connected to the second conductive strip and a second electrical ground;
wherein a second tuning equivalent capacitance is adapted to be selectively generated between the combined transmission line and the second conductive strip based on a second switch state of the second switch.
